(19) United States
(12) Patent Application Publication
(10) Pub. No.: US 2019/0257801 A1
(43) Pub. Date: Aug. 22, 2019

(54) UNIFORMLY DENSE STATIONARY PHASE FOR CHROMATOGRAPHY

(71) Applicant: Purdue Research Foundation, West Lafayette, IN (US)

(72) Inventors: Mary J. Wirth, West Lafayette, IN (US); Alexis Huckabee, West Lafayette, IN (US); Rachel Jacobson, West Lafayette, IN (US); Tse-Hong Chen, West Lafayette, IN (US)

(73) Assignee: Purdue Research Foundation, West Lafayette, IN (US)

(21) Appl. No.: 16/310,969

(22) PCT Filed: Jun. 21, 2017
(86) PCT No.: PCT/US17/38431

§ 371 Date: Dec. 18, 2018

Related U.S. Application Data
(60) Provisional application No. 62/352,794, filed on Jun. 21, 2016.

(51) Int. Cl. G01N 30/56; B01J 20/286; B01J 20/32; B01D 15/20

(52) U.S. Cl. CPC G01N 30/56; B01J 20/286; B01J 20/327; G01N 2030/528; B01J 20/3204; B01J 20/3278; B01J 20/3293; B01D 15/206

(57) ABSTRACT

The present disclosure relates to a chromatographic stationary phase having a uniform polymer density, and related methods. In particular, the present disclosure relates to a method of forming a uniformly dense stationary phase inside a chromatography column.

### RELATED APPLICATIONS

This application claims priority to U.S. Provisional Patent Application No. 62/352,794 filed on Jun. 21, 2016, the contents of which are incorporated herein in their entirety.

### STATEMENT OF GOVERNMENT INTEREST

This invention was made with government support under Grant No. 41020000/800005984 awarded by the National Institutes of Health (NIH). The government has certain rights in this invention.

### FIELD OF THE TECHNOLOGY

The present disclosure relates to a chromatographic. stationary phase having a unifbrm density, and related methods. In particular, the present disclosure relates to a method of forming a uniformly dense stationary phase inside a chromatography column.

### BACKGROUND

Chromatography columns having polymer based stationary phases are an essential tool for the analysis of biological samples and the development of biological related drugs, e.g., protein drugs. Current polymer based chromatography columns are unstable and provide insufficient resolution of complex samples. The present disclosure relates to an improved chromatographic stationary phase having uniform density and applicable to the analysis of biological samples.

### SUMMARY

The present disclosure relates to a chromatographic stationary phase having a uniform density, and related methods. In particular, the present disclosure relates to a method of forming, or growing, a uniformly dense stationary phase inside a chromatography column. The stationary phase can be a surface-confined polymer grown on a packed chromatography column.

In one embodiment, the present disclosure relates to a method of preparing a chromatography column, including (i) packing the chromatography column with support particles to form a packed support particles within said column, and (ii) forming a polymer coating on the packed support particles.

In another embodiment, the present disclosure relates to a chromatography material including (i) support particles, and (ii) an initiator on a surface of the support particles,

In a further embodiment, the present disclosure relates to a chromatography column including (i) support particles, (ii) an initiator on the surface of the support particles, and (iii) a polymer coating on the surface of the support particles. The support particles can include hard contacts between support particles.

The present disclosure provides a number of advantages over current chromatography columns and methods. For instance, the chromatography column and method of the present disclosure can form or grow polymer layers on support particles after the support particles are packed tightly, uniformly and stably inside the column. These chromatography columns exhibit improved stable and higher resolution than current chromatography columns,

### BRIEF DESCRIPTION OF THE DRAWINGS

The foregoing and other features and advantages provided by the present disclosure will be more fully understood from the following description of exemplary embodiments when read together with the accompanying drawings, in which

FIG. 1 shows an exemplary comparison of support particles packed conventionally (a) and support particles packed using the in-column polymer growth (b).

FIG. 2 shows an exemplary comparison of an ion chromatography separation of pharmaceutical grade monoclonal antibody using a column having support particles conventional packed (a), and a column having support particles packed using the in-column polymer growth (b). The column having support particles packed using the in-column polymer growth shows improved resolution.

FIG. 3 shows Ribonuclease B (Ribo B) is used as a model glycoprotein for determining the HILIC surface's specificity to glycan chains. The solid spheres represent the protein and the stick structures represent the sugar group. Ribo B's glycans vary from five to nine mannose groups.

FIG. 4 shows silica particles modified with ((chloromethyl)phenylethyl)-trichlorosilane, which bears the chlorine (Cl) initiator and trimethylchlorosilane, which acts as a spacer. Next an AGET ATRP reaction is performed to grow the polyacrylamide on the silica surface. The B represents the phenyl ring that the Cl is attached to,

FIG. 5 shows that the polyacrylamide PAAm layer is the primary factor in separation. The brush layer of PAAm becomes hydrated with water and is closely spaced to sterically exclude the protein. This exclusion allows separation solely based on the carbohydrate interaction with the water in the PAAm layer.

FIG. 6 shows a Free Particle (FP) column, which was made by coating the particles with polymer before packing, and an ICAAM column, which was made by polymer growth in the packed column. Black represents the benzyl chloride monolayer and orange represents polyacrylamide brush layer. The polymer is compressed between the particles when pre-modified particles are packed into the FP column. This does not occur when benzyl chloride (BC) particles are packed and then polymerized. The BC particles are in direct contact, limiting packed bed compression and polymer layer deformation.

FIGS. 7A-7L show separation parameters for ribonuclease B. Gradient: 75-60% B acetonitrile (ACN) in 20 min. Tm=30° C.. Injection volume: 2 μL, dp=750 nm, & L=3 cm, FIGS. 7A-7D show an overlay of the 1st, 20th, & 40th run chromatograms at 215 nm & IPW. FIGS. 7E-7H show chromatograms at 280 nm detection λ. Polymer growth inside the packed column also prevents particles from leaking through the detector, and the spikes in FIG. 7G illustrate that this is a problem when the polymer growth is done before packing.. FIGS. 7I-7L show Back Pressure vs Time Graphs during chromatographic separations.

FIG. 8 shows that during the manufacturing process, mAb glycosylation can be altered. Since mAb glycosylation affects biological activity and immunogenicity, separation and characterization of mAbs is desirable for a functional and safe pharmaceutical product.

FIGS. 9A and 9B show a depiction of the structural distinction between columns packed with particles that A) had polymer grown before packing (ex situ) vs. B) particles containing initiator but no polymer, with the polymer subsequently grown on the particle surface inside the column (in situ).

FIGS. 10A-10D show the effect of polymer growth time on the HILIC chromatogram of ribonuclease B. A) Increase in back-pressure during in-column polymer growth over 55 min. Pressure drop over the first 2 min is caused by a step-decrease in flow rate from 200 μL/min, for filling the column with reagent, to 100 μL/min during the reaction. The solvent is 25:75 IPA:water, B, C, D) Chromatograms for growth times of 20, 40 and 55 min, respectively. The gradient 75-60% acetonitrile in water, with 0.1% trifluoroacetic acid, over 20 min at 100 μL/min, 30° C. injection volume 2 μL, and detection at 215 nm.

FIG. 11A shows calculated porosity and FIG. 11B shows calculated polymer thickness during in situ growth. These graphs are derived from the pressure vs. reaction time data in FIG. 10A through the Kozeny-Carman and hydrodynamic radius equations in the text,

FIGS. 12A-12H show HILIC data for ribonuclease B and the corresponding plots of back-pressure during the gradient elutions. 40 runs were done for each panel, which show the runs for the 1st, 20th, and 40th runs. The flow rates listed regard the chromatographic separations. A) HILIC for ex situ growth with a flow rate of 100 μL/min and B) the corresponding back-pressure, C) HILIC for ex situ growth with a flow rate of 150 μL/min and D) the corresponding back-pressure. E) HILIC for in situ growth with a flow rate of 100 μL/min. and F) the corresponding back-pressure. G) HILIC for in situ growth with a flow rate of 150 μL/min and H) the corresponding back-pressure. The gradient was the same as in FIG. 10.

FIGS. 13A-13C show profiles of unretained peaks for three different columns, A) column packed with particles bearing only initiator, B) same column as A but after 55 min of polymer growth, also same column as in FIG. 12G, and C) column packed with particles polymerized ex situ for 55 min, also same column as in FIG. 12C. In each case, 2 μL of pure acetonitrile was injected into a mobile phase of 50:50 acetonitrile:water and eluted isocratically, with a flow rate 150 μL/min.

FIGS. 14A-14B show chromatograms of ribonuclease B for the best three of eight columns made by A) ex situ and B) in situ polymer growth. FIGS. 14C-14D show chromatograms for the remaining five of eight columns made by C) ex situ and D) in situ polymer growth. The gradient was the same as in FIGS. 10 and 14.

FIG. 15 shows that IgG2 drugs undergo disulfide scrambling.

FIG. 16 shows a comparison of a polymethylmethacrylate column with a commercially available column for an IgG2 therapeutic protein. All chromatograms are for the same 20 min gradient of water-acetontrile with 0.1% TFA.

FIG. 17 shows that longer alkyl chain length decreases selectivity for IgG2.

FIG. 18 shows that a long gradient time with polymethylmethacrylate increases resolution.

FIG. 19 shows that selectivity is much higher for polymethylmethacrylate than C8 bonded phase.

FIG. 20 shows that for polymethylmethacrylate (PMMA), selectivity is better with formic acid.

FIG. 21 shows that the PMMA layer has ˜15X lower interfacial potential due to its 5 nm thickness, compared with ˜1 nm for conventional hydrocarbon bonded phase.

FIG. 22 shows RPLC. using a polymethylmethacrylate column and 0.25% formic acid, both MS and UV detection. A: Water, 0.25% formic acid. B: Acetonitrile, 0,25% formic acid, Gradient: 17-26% B in 30 min. Column temp,: 50° C. Flow rate: 100 uL/min.

FIG. 23 shows a chromatogram of the same IgG4 sample used in FIG. 22 with the Agilent core-shell side wide-pore column with 0.1% TFA and 3% butanol at 80° C. The later time is from starting the gradient earlier to scope out possible fragments that elute earlier.

### DETAILED DESCRIPTION

The present disclosure relates to a chromatographic stationary phase having a uniform density, and related methods. In particular, the present disclosure relates to a method of forming a uniformly dense stationary phase inside a chromatography column.

In one embodiment, the present disclosure relates to a method of preparing a chromatography column, including (i) packing the chromatography column with support particles to form packed support particles within the column, e.g., a packed column; and (ii) forming a polymer coating on the packed support particles.

The chromatography columns can be used with any chromatography technique including ion exchange chromatoomphy, hydrophilic interaction chromatography, hydrophobic interaction chromatography, reversed phase chromatography and any other chromatographic method that uses a bonded phase.

The support particles can be any support particles capable of being used with one of the chromatography techniques and capable of forming or growing a polymer coating thereon. The support particles can include silica, polymer, lumina, titania, zirconia, magnetite, or combinations thereof, such as silica cladded with zirconia. In particular, the support particles can be silica. In some embodiments, supports other than particles can be used, including monolithic silica and 3D printed columns,

The support particles can have a certain hardness or rigidity, such as hard-sphere silica particles. In some embodiments, the particles can be porous or non-porous. In other embodiments, the particles are non-porous or substantially non-porous. A hard particle is one that does not compress under pressures used in chromatography, for example pressures that range from 1,000 to 18,000 psi. The size of the support particles can vary depending on the size of the column to be packed. in certain embodiments, the particle size is 0,1, 0,2, 0,3, 0,4, 0,65, 1.2, 2, 3, 4, 5, 6, 7, 8, 9, 10. 20, 30, 40, 50, 60, 70, 80, 90 or 100 μm. Any of these values may he used to define a range for the particle size. For example, the particle size may be 0.2 to 100 μm, 1 to 10 μm, or 1 to 100 μm.

The column can be packed by conventional means including slurry packing and slurry packing with sonication. The packed column can be one in which the support particles are packed tightly, uniformly and stably inside the column. The packed column can include hard contacts between support particles. These hard contacts can be formed by packing the support particles together in the column without a stationary phase or polymer coating applied to the surface. The amount or number of hard contacts in the packed support particles in the column is the same, or substantially the same, before and after the polymer coating is formed on the particles. For example, for a column that is 2.1 mm inner diameter and 50 mm in length, packed with 1.2 um particles, the polymethylmethacrylate thickness is 5 mm and the back-pressure remains just below 4,000 psi.

A polymer coating can be formed or grown on the packed support particles. The particles can have surface chemistry and/or initiator that enables attachment various substituents, including polymers, polymer chains, peptides, oligonucleotides, and the like, and combinations thereof. In one embodiment, the support particles can include an initiator. The initiator can be bound to the support particles before or after the support particles are packed into the column. The initiator can be used to initiate the formation of the polymer coating on the support particles. In some embodiments, the initiator may contain a chlorosilane group for covalent binding to silica, or a functionality that can bind to a silane.

The initiator can be any compound capable of being attached or bound to the support particles and initiating the formation of the coating on the support particles, Commonly known initiators are provided in Coessens, V., et al., Prog. Polyrrn. Sci. 2001, 26, 337-377, the entire disclosure of which is incorporated herein in its entirety. The initiator can he selected from, but are not limited to, ((chloromethyl)phenylethyptrimethoxysilane, (3-trimethoxysilyl) propyl 2-bromo 2-methylpropionate, [11-(2-bromo-2-methyl)propionyloxy]undecyltrichlorosilane, cyanomethyl [3-(trimethoxysilyi)propyl]trithiocarbonate, triethoxyaminopropylsilane, glycidoxypropyltrimethoxysilane, or combinations thereof.

In one embodiment, the initiator on the particle surface can enable polymer growth through atom-transfer radical polymerization (ATRP). The initiator can be, but is not limited to, ((chloromethyl)phenylethyl)trimethoxysilane, (3-trimethoxysilyl) propyl2-bromo 2-methylpropionate, [11-(2-bromo-2-methyl)propionyloxy]undecyltrichlorosilane, or combinations thereof.

In another embodiment, the surface chemistry / initiator can be an activator generated by electron transfer (AGET) and used with ATRP for growth of the polymer. In certain embodiments 6 mL of liquid methyl methacrylate; 20 mL of 45% water 55% IPA; 0.020 g of sodium ascorbate; 2.5 mL solution of 45% water 55% IPA; 0.040 g of copper (II) chloride; 2.5 ml solution of 45% water 55% IPA; 80 uL: of Tris(2-dimethylaminoethypamine (Me6TREN) are used. The present disclosure relates to a method of preparing a chromatography column, including (i) packing the chromatography column with support particles to form a packed support particles within said column, and (ii) forming a bonded phase (e.g., polymer coating) on the packed support particles, wherein the formation of the bonded phase uses activators generated by electron transfer along with ATRP. One advantage of using this method is the formation can be readily accomplished under ambient conditions.

In another embodiment, the initiator on the particle surface can enable polymer growth through reversible addition fragmentation chain transfer (RAFT). The initiator can be, but is not limited to, cyanomethyl [3-(trimethoxysilylpropyl]trithiocarhonate.

In another embodiment, the initiator on the particle surface can enable growth of a peptide through solid-phase peptide synthesis. The initiator can be, but is not limited to, triethoxyarninopropylsilane, glycidoxypropyltrimethoxysilane, or combinations thereof.

Similarly, in another embodiment, the initiator on the particle surface can enable growth of oligonucleotide chains. The initiator can be, but is not limited to, triethoxyaminopropylsilane, glycidoxypropyttrimethoxysilane, or combinations thereof.

The amount of initiator can vary depending on the initiator, the support particles, the polymer coating and other factors. The amount of initiator can be about 0,05, 0.1, 0.2, 0,3, 0,4, 0,5, 0.6. 0.7 0.8, 0.9, 1, 1.1, 1.2, 1,3, 1.4, 1,5, 1,6, 1,7, 1,8, 1,9, 2, 2.0. 2.1. 2.2. 2.3, 2.4, 2,5, 2,6, 2.7, 2.8, 2.9, 3, 3.1, 3.2, 3.3, 3.4 or about 3.5 μM/m². These values can define a range, such about 0.1 to about 3 μM/m².

Polymer brush layers covalently bound to particles, including silica and polymeric particles, can be used as separation media in process-scale and analytical scale chromatography columns in the pharmaceutical industry, Currently, the polymers are first formed on the particles and are thereafter packed into the column. In one embodiment, the present disclosure involves one or more of the support particles including or bearing an initiator for polymerization such that the polymer is not grown, or completely grown, until the support particles are already packed.

The chromatography columns of the present disclosure can be prepared using the method of surface confined atom-transfer radical polymerization. Surface confined atom-transfer radical polymerization is a well-established method for growing polymers from a surface-bound initiator, see, e.g,, Banerjee. S., et al., Polym. Chem., 2014, 5, 4153-4167, the entire disclosure of which is incorporated herein in its entirety. In some embodiments, the initiator on the particle surface can enable polymer growth through atom-transfer radical polymerization (ATRP).

The polymer coating can include any polymer capable of coating the support particles and forming a uniformly dense coating that is useful for chromatography. The polymer can be a homopolymer, a copolymer or a block copolymer. The polymer can include, for example, linear polyacrylamide (e.g., HILIC), hydrophobic polymers, such as butylmethacrylate and other methacrylates (e.g., HIC), and acrylic acid and other charged polymers (e.g.. Ion Chrom,). In other embodiments, the polymer can be selected from, but not limited to, styrenes, acrylates, methacrylates, methacrylamides, vinyl esters, vinyl amides and combinations thereof, in particular, the polymer can be polyacrylamide, polyrnethacrylate, polyphenylmethacrylate, polymethylmethacrylate, polyethylmethacryclate, polybutylmethacrylate, 2-(diethylamino)ethylmethacrylate or combinations thereof. in particular, the polymer can be a combination of polyacrylamide and polymethylmethaerylate,

In one embodiment, the polymer can include the polymer stationary phase components as described in pending U.S. patent application Ser. No. 14/355,595, the entire disclosure of which is incorporated herein in its entirety. For example, the present disclosure can utilize random copolymers or acrylamide and glycidoxylmethacrylate. The weight percent values of the different combinations, as described throughout the disclosure, can vary over a wide range, such as from about 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15 to about 1:20. These values can be used to describe range of weight percent values, such as, 20:1 to about 1:1,

A polymer or pre-polymer solution can be introduced to the support particles in the column, such as, by introducing the polymer or pre-polymer solution to the packed column. The polymer coating can be affected by the reaction conditions and the reaction time allowed for polymerization. The polymer can grow approximately linearly with reaction time. For example, a 3M monomer solution can be reacted for about 30 to about 60 minutes to generate a polymer coating. The resulting polymer coating can be tens of nanometers in thickness. The thickness of the coating can be varied by adjusting the time to shorter or longer times.

In one embodiment, the support particles can include an initiator on a surface of the support particles and the forming of a polymer coating can include growing the polymer coating on the surface of the support particles.

The resulting polymer coating on the support surface can have a substantially uniform density throughout the packed column. Uniform density means no polymer is compressed between particles during packing. For example, a substantially uniform density is one that does not vary by more than about 1%, 2, 3, 4, 5, 6, 7, 8, 9, 10, 12, 14, 16, 18, 20, 25, 30, 35, 40, 45 or about 50%. These values can define a range, such as about 2% to about 10%. The method of packing the column first followed by forming the polymer coating can help form a substantially uniform density by, for example, eliminating the interaction of two pre-coated support particles. The interaction of two pre-coated support particles can form areas of higher density polymer coating at the points where the two particles interact or contact.

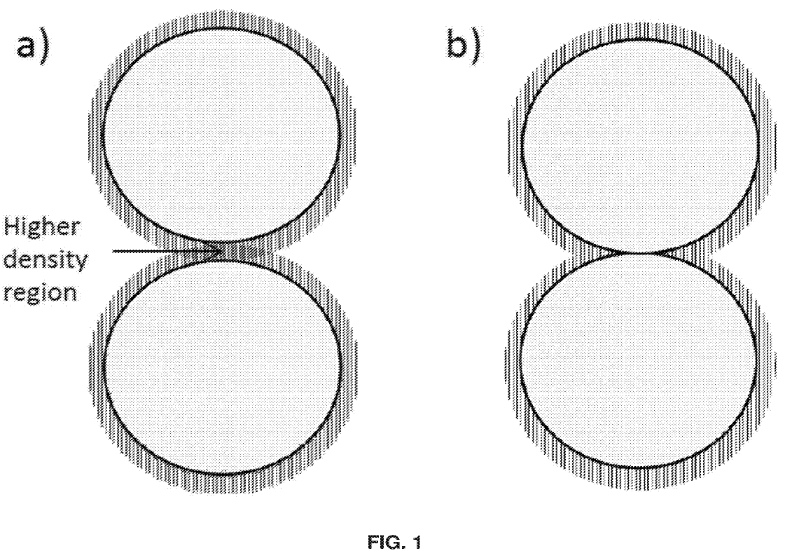

FIG. 1 shows an exemplary illustration of support particles packed conventionally having an area of higher density polymer coating (a), and support particles packed using the in-column polymer growth (b). In FIG. 1(a) the conventional method forces polymer compression which can negatively affect chromatography of protein drugs. In FIG. 1(b) the packed hard-sphere silica particles provide a stable packed column to grow the polymer coating on without causing deleterious compression.

The thickness of the polymer coating can be about 0.1, 0.5, 1, 2, 3, 4, 5, 6, 7, 8, 9, 10, 12, 14, 16, 18, 2.0, 30, 40, 50, 60, 70, 80, 90, 100, 110, 120, 130, 140 or about 150 nm. These values can be used to define a range, such as about 3 to about 20 nm, or from about 20 to about 25 nm. The density of the polymer coating can be about 0.005, 0.01, 0.05, 1, 2, 3 or about 4 μmol/m². These values can be used to define a range, such as about 0.01 to about 1 wriollm².

In one embodiment, the polymer coating can be formed by measuring the back-pressure over time during the forming step. The polymer coating can be grown by flowing a pre-polymer solution through the column at high rate or pressure. The high rate or pressure can be the near the maximum allowed by the instrumentation used. After initially pumping the solution into the column, the rate or pressure can be reduced, such as by about 50%, and monitored. The pressure to maintain the reduced rate can gradually rise as the polymer coating is formed. The reaction can be allowed to proceed until the time or pressure reaches a desired value, such as about 1 hour or about 10,000 psi. The reaction time can be about 0.1, 0.2, 0.3, 0.4, 0.5, 0.6, 0.7, 0,8, 0.9, 1, 1.1, 1.2, 1.3, 1.4, 1.5, 2, 2,5, 3, 3.5, 4, 4.5 or about 5 hours° These values can be used to define a range, such as about 0.5 to 2 hours. The reaction pressure can he about 5000, 5500, 6000, 6500, 7000, 7500, 8000, 8500, 9000, 9500, 10000, 11000, 12000, 13000, 14000 or about 15000. These values can he used to define a range, such as about 8000 to about 12000 psi.

In another embodiment, the reaction can be allowed to proceed at a constant pressure, such as defined above, and the reaction can be stopped at a desired flow rate. The desired flow rate can be about 0.1, 0.5, 1, 5, 10, 20, 30, 40, 50, 60, 70, 80, 90, 100, 110, 120, 130, 140, 150, 160, 170, 180, 190, 200, 250, 300, 350, 400, 450 or about 500 μL/min. These values can be used to define, a range such as about 10 to about 100 μL/min.

In another embodiment, the polymer coating can be formed without flowing a solution, e.g., a pre-polymer solution or reagent solution, through the column. The solution can be introduced to the column, initially flow through, etc., then the polymer coating can be allowed to form without flow, or constant flow, or continuous flow, through the column. The column can still be held under pressure and allowed to react, as provided above. In another embodiment, the present disclosure is related to a chromatography material including (i) support particles, and (ii) an initiator on a surface of the support particles.

In another embodiment, the present disclosure is related to a chromatography column including (i) support particles, (ii) an initiator on the surface of the support particles, and (iii) polymer coating on the surface of the support particles. The support particles can have hard contacts between particles.

The chromatography columns of the present disclosure can improve resolution compared to prior art columns. As demonstrated in the examples, higher chromatographic resolution was observed for in situ polymer growth as evaluated by HIL chromatography for glycoprotein ribonuclease B. Resolution is measured by the ratio of peak distance to peak base. The chromatography columns of the present disclosure can improve resolution by about 10%, 20, 30, 40, 50, 60, 70, 80, 90 or by about 100% compared to prior art columns, such as those not formed by the methods of the present disclosure. These values can be used to define a range such as about 10% to about 30%. The chromatography columns of the present disclosure can improve resolution by about 1.5×, 2×, 3×, 4×, 5×, 6×, 7×, 8×, 9× or about 10× compared to prior art columns, such as those not formed by the methods of the present disclosure. These values can be used to define a range such as about 2× to about 4×.

The chromatography columns of the present disclosure can have improved column-to-column reproducibility as compared to prior art columns, As demonstrated in the examples, better column-to-column reproducibility was observed for in situ polymer growth as evaluated by HIL chromatography for glycoprotein ribonuclease B. Column-to-column reproducibility can be assessed by the method provided in Example 2, The chromatography columns of the present disclosure can improve reproducibility by about 10%, 20, 30, 40, 50, 60, 70, 80, 90 or by about 100% compared to prior art columns, such as those not formed by the methods of the present disclosure. These values can be used to define a range such as about 20% to about 40%. The chromatography columns of the present disclosure can improve reproducibility by about 1.5×, 2×, 3×, 4×, 5×, 6×, 7×, 8×, 9× or about 10× compared to prior art colurrms, such as those not formed by the methods of the present disclosure. These values can be used. to define a range such as about 2× to about 5×.

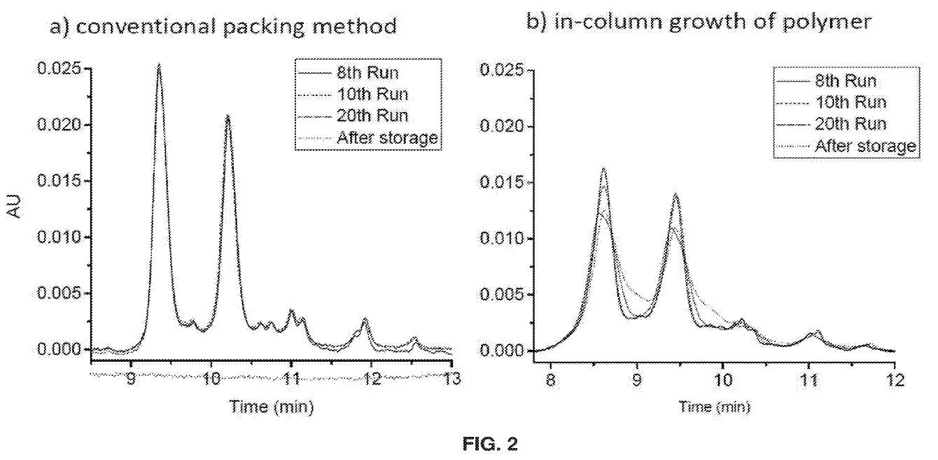

The chromatography columns of the present disclosure can also give lower eddy diffusion values as compared to prior art columns. A significant limitation to the chromatographic performance of sub-2 μm particles is the difficulty in achieving uniform packing; packed columns exhibit radial heterogeneity in packing, which deteriorates performance. This effect is called eddy diffusion. Eddy diffusion is a measure of the unikumity of flow paths through the column. For example, a 100 μm inner diameter (i.d.) column of packed silica particles exhibits a contribution of 1.0 μm to the length-normalized peak variance (commonly called height equivalent to a theoretical plate) due to eddy diffusion (Anal, Chem, 76: 5777-5786, 2004). The uniformity degrades in the conventional art because particles move around due to the elasticity of the polymer in the contact regions. In one embodiment, the present disclosure can be useful for the characterization of protein variants in monoclonal antibodies and antibody-drug complexes where non-denaturing separations can be used to so that the separated components can he individually studied for efficacy toxicity and mechanism of action. FIG. 2 shows an exemplary comparison of a chromatography separation of pharmaceutical grade monoclonal antibody using a column having support particles conventional packed (a) a column having support particles packed using the in-column polymer growth (b), The column having support particles packed using the in-column polymer growth shows improved resolution. The lower resolution of the conventional column is attributed to higher eddy diffusion to the positional instability of the particles, which causes them to open up gaps.

This is a precursor to bed collapse. The improved resolution using the chromatography column and method of the present disclosure can enable more species to be isolated from the mixture and studied, thus removing a barrier to drug development.

The chromatography columns of the present disclosure can improve column stability compared to prior art columns. Column stability can be measured by the onset of column failure at high flow rate (i.e, bed collapse), which can cause accelerated aging due to the shearing. For columns packed with 1.5 μm particles, bearing a layer of 10 nm of polyacrylamide, having dimensions of 2.1 mm×50 mm, the onset of ⁻failure for a column made by prior art is 150 μL/min.

The chromatography, columns of the present disclosure, having similar parameters, can operate at flow rates up to, or more than, 100, 110, 120, 130, 140, 150, 160, 170, 180. 190, 200, 250, 300, 350, 400, 450 and up to about 500 μL/min. These values can be used to define a range such as about 160 to about 200 μL/min.

The chromatography columns of the present disclosure can improve column stability by about 10%, 20, 30, 40, 50, 50, 70, 80, 90 or by about 100% compared to prior art columns, such as those not formed by the methods of the present disclosure. These values can be used to define a range such as about 20% to about 50%. The chromatography columns of the present disclosure can improve column stability by 1.5×, 2×, 3×, 4×, 5×, 6×, 7×, 8×, 9× or about 10× compared to prior art columns, such as those not formed by the methods of the present disclosure. These values can be used to define a range such as about 2× to about 5×.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed, Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

While this disclosure has been particularly shown and described with reference to example embodiments thereof, it will be understood by those skilled in the art that various changes in form and details may be made therein without departing from the scope of the invention encompassed by the appended claims.

### EXAMPLES

### Example 1

A new method to make polymer bonded phases was evaluated to yield more stable and efficient columns for intact glycoproteins. Polyacrylamide was horizontally polymerized on initiator bearing silica nanoparticles packed inside a chromatographic column. The reaction was performed under a moderate flow rate, rather than the conventional method of packing pre-modified particles. Activator generated by electron transfer for atom transfer radical polymerization (AGET ATRP) was used to grow the polymer. Since the initiator particles were grown on particles that are already packed tightly and uniformly, this column is more stable and provides at least two-fold higher resolution than a conventionally packed column.

Glycosylation is a necessary component of many protein activities; thus, separations of intact glycoproteins are important in biologic drug fbrmulation. One of the barriers to efficient glycoprotein separations is bonded phase instability of the chromatographic column. Therefore, advances in polymer durability to improve column longevity and resolution would benefit pharmaceutical. R&D.

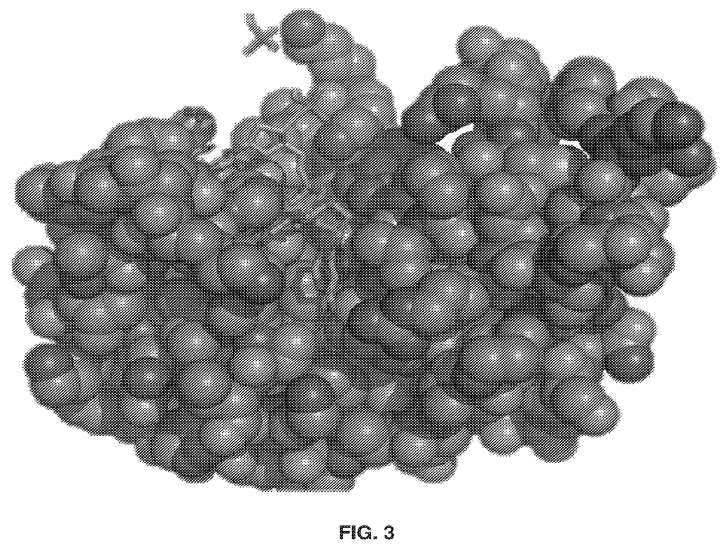

In the experiments described below, Ribonuclease B (Ribo B) was used as a model glycoprotein for determining the 1-HILIC surface's specificity to glycan chains. The solid spheres represent the protein and the stick structures represent the sugar group. Ribo B's glycans vary from five to nine mannose groups. See FIG. 3.

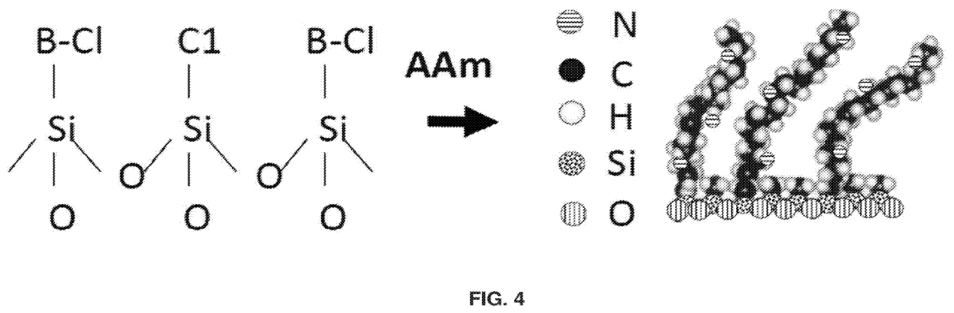

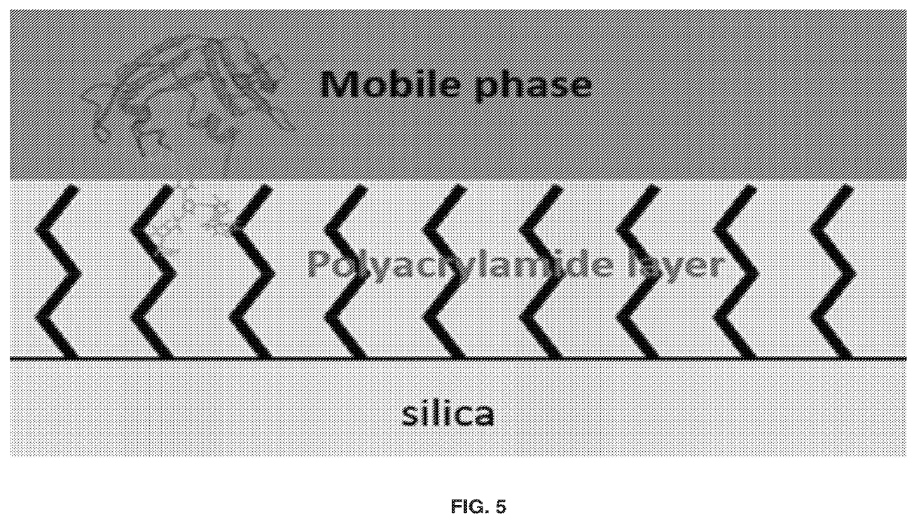

It was previously demonstrated that horizontal polymerization of acrylamide (AAm) onto nonporous silica. nanoparticles forms a brush layer of polymer chains (FIG. 4). Once hydrated, these polyacrylamide chains provide an excellent hydrophilic liquid chromatography (HILIC) surface for intact glycoproteins (FIG. 5). This column is termed free particle column (FP), denoting that the particles are modified prior to packing.

After 20-40 runs on a FP column, the resolution decreases. Polymer compression limits FP columns, weakening PAAm bonds and causing polymer to shear at high flow rates. Shear forces arise from velocity gradients perpendicular to the direction of flow. A PAAm chain longer than its neighbors is especially vulnerable to shear. Shearing of a FP column narrows the PAAm layer, lowering resolution and stability.

To prevent loss of bonded phase, an AGET ATRP was performed under a moderate flow rate of 100 μL/min inside a column. This forces the AAm to grow in one direction, while uneven polymer is removed via shear. This method is termed in-column AGET ATRP modification (ICAAM).

Having unidirectional, even length polymer chains will improve resolution, and growing the polymer on solid particles in contact with one another will improve packed bed stability (FIG. 6). This is because the polymers are not compressed during packing and are made even due to shear. (Note: IPW injected peak width)

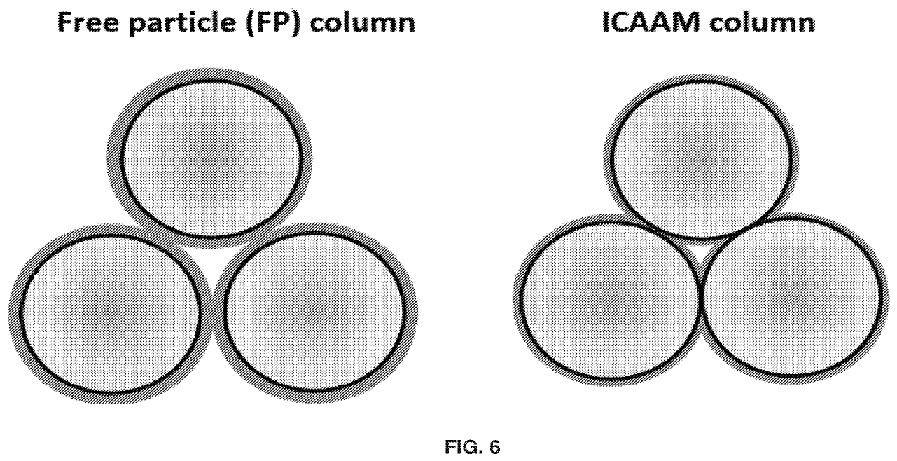

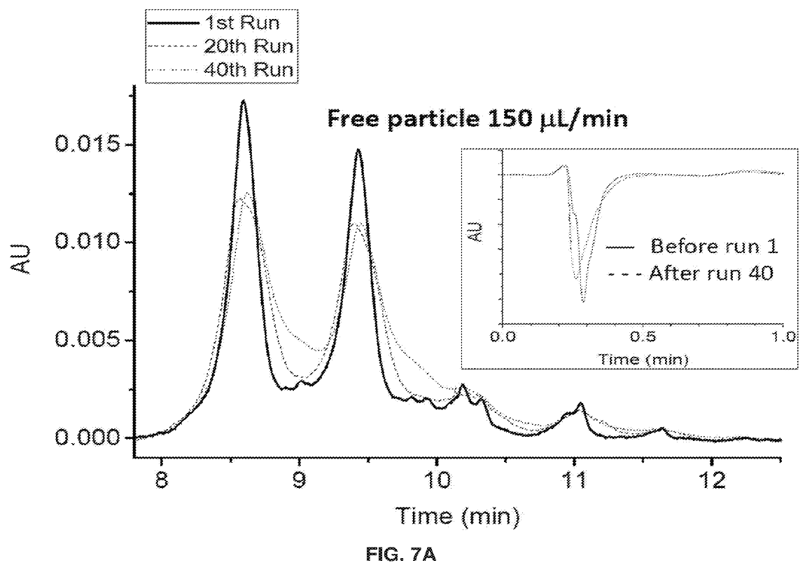

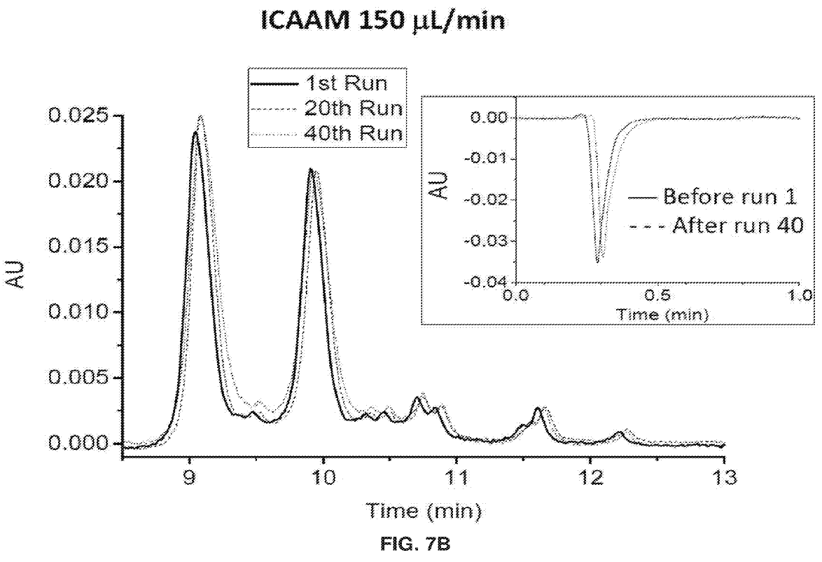

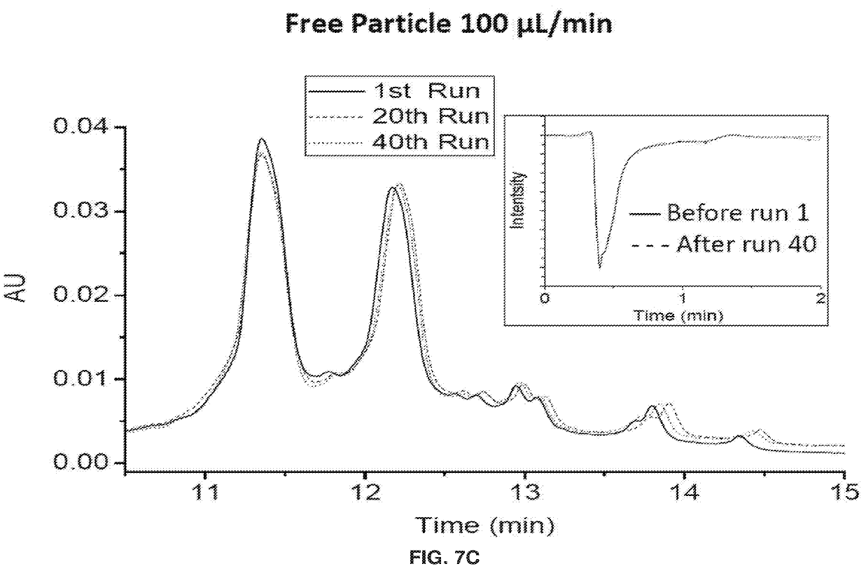

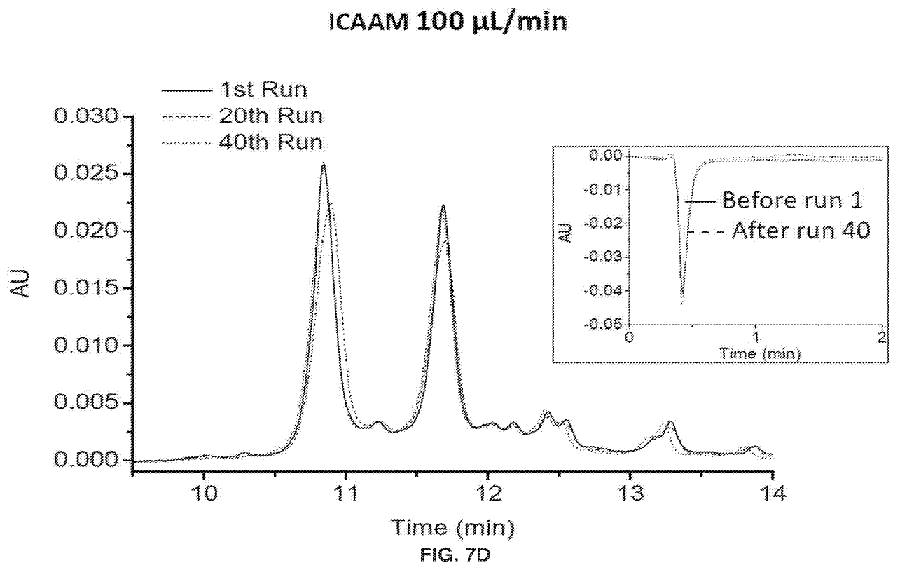

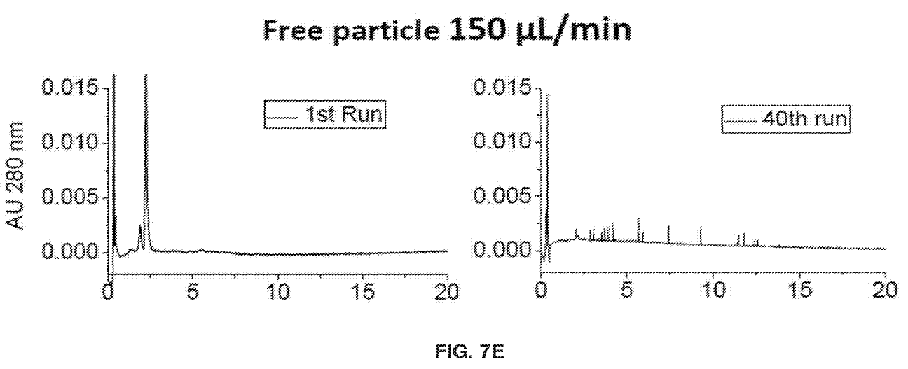

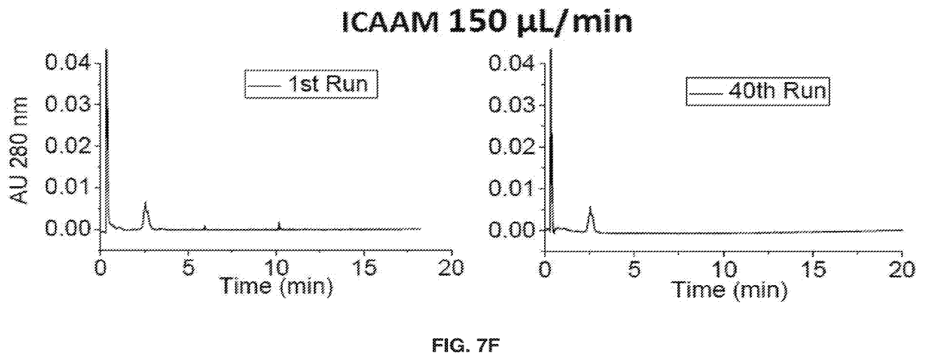

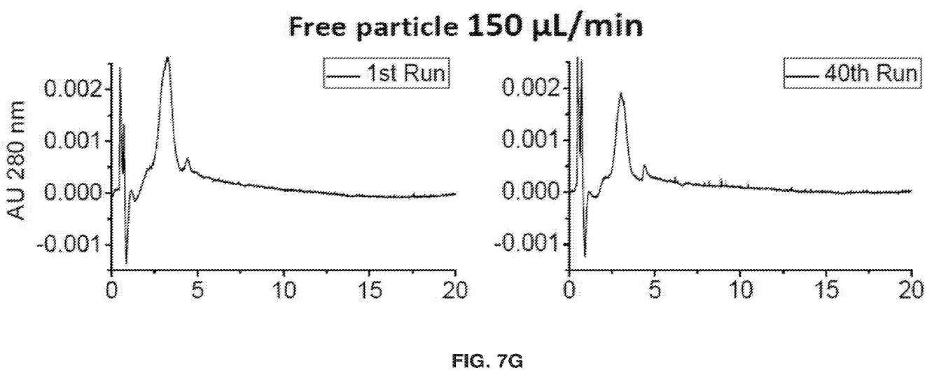

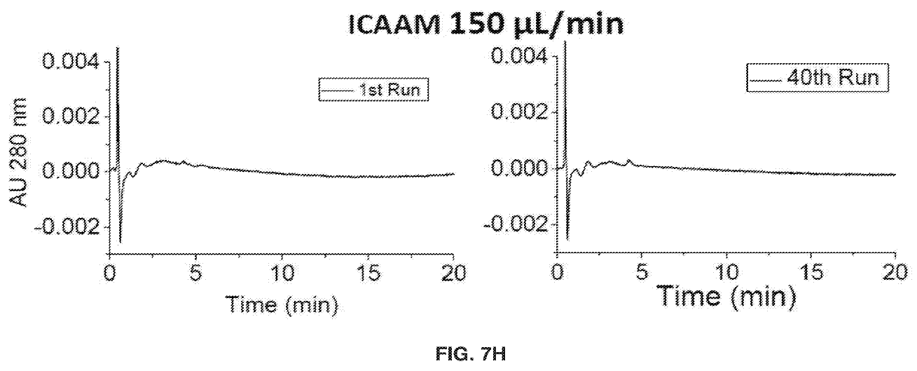

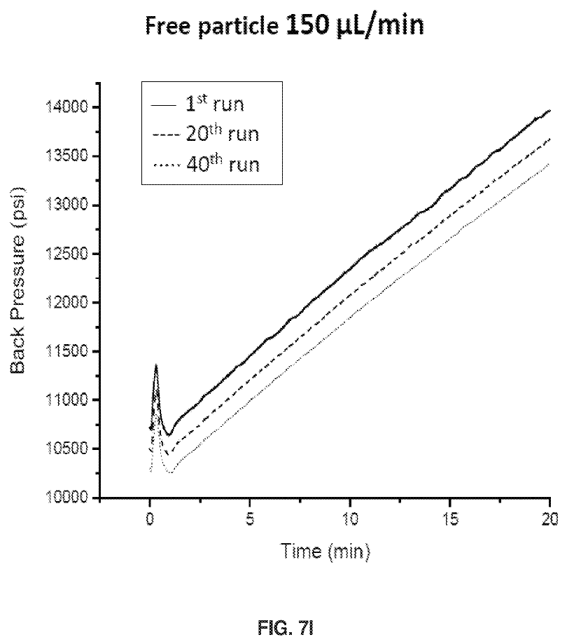

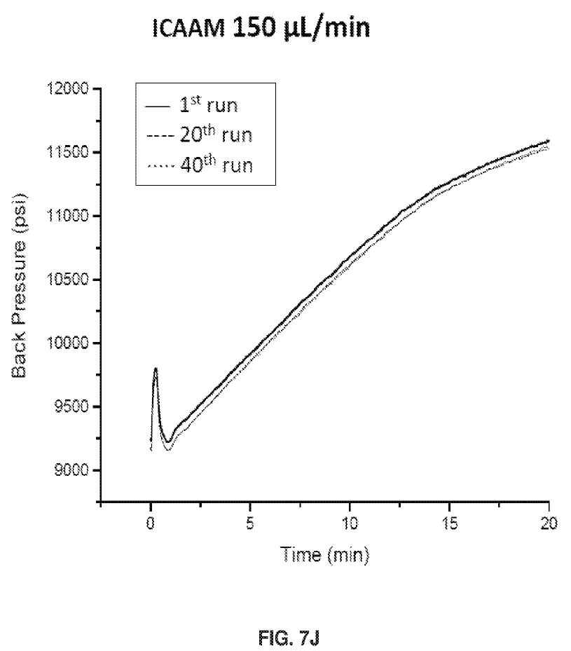

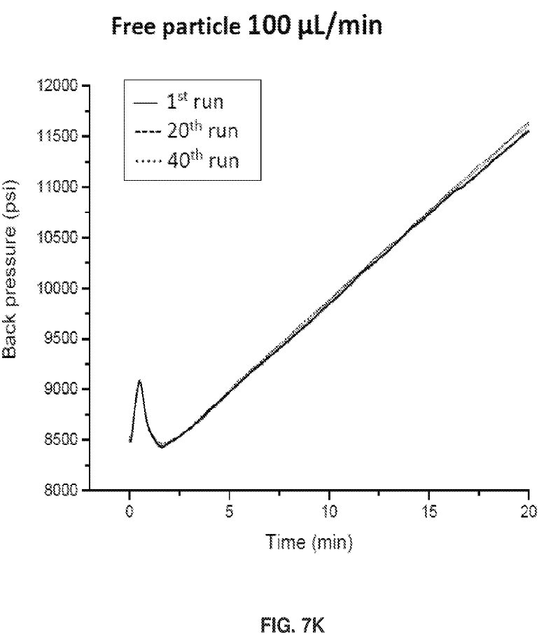

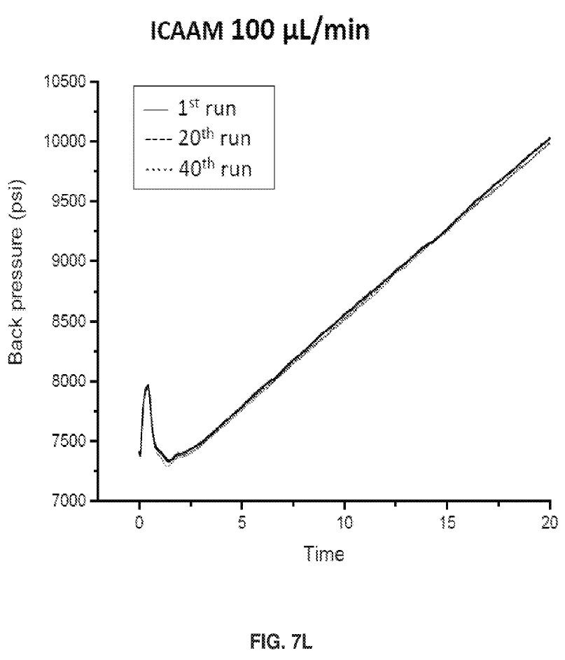

FIGS. 7A-7L show separation parameters for ribonuclease B under the following conditions: Gradient: 75-60% B (ACN) in 20 min. Tm=30° C.. Injection volume: 2 μL, dp=750 nm, & L=3 cm. FIGS. 7A-7D show an overlay of the 1st, 20th, & 40th run chromatograms at 215 nm & IPW. As shown in FIG. 7A, the resolution and column stability decrease with number of runs. IPW show free column volume remains constant, thus the packed bed is not the cause of degradation. As shown in FIG. 7B, uniformity of the packed bed, parallel polymer chains, and uneven polymer shear while modifying the column contribute to higher resolution, As shown in FIG. 7C, at lower low rates, shear can be reduced or eliminated for FP columns. The resolution and column stability is conserved. As shown in FIG. 7D, the resolution and column stability is conserved over many runs.

FIGS. 7E-7H show chromatograms at 280 nm detection to show acrylainide bleed. As shown in FIG. 7E, with Free Particle 150 μL/min, sharp peaks indicate acrylamide bleeding from the column due to shearing. No acrylamide bleeding from the column was detected for ICAAM 150 μL/min (FIG. 7F). Free Particle 100 μL/min (FIG. 7G), or ICAAM 100 μL/min (FIG. 7H).

FIGS. 7I-7L show Back Pressure vs Time Graphs during chromatographic separations. As shown in FIG. 7I. Free Particle 150 μL/min pressure decrease is caused by polymer shearing off. The ICAAM columns maximum flow rate is 150 μL/min. The column reached its maximum pressure indicated by the curve. See FIG. 7J. When polymer does not fall off the pressure remains constant for FP columns. See FIG. 7K. For ICAAM 100 μL/min, the column did not reach maximum pressure, thus no curve was observed. See FIG. 7L

The FP column was found to be mainly limited by polymer manipulation and compression of the packed bed, lowering resolution over time of intact glycoproteins. As shown with a FP column run at 150 μL/min, shear begins to affect column performance after the 20th run. As runs continue, more acrylamide peaks appear, and resolution decreases drastically. At a lower flow rate (100 μL/min), shearing does not occur.

In ICAAM, initiator modified particles are packed tightly in the column, improving stability. Since the polyacrylamide chains are polymerized under solvent flow, the polymers lengthen in one direction and any loose or uneven polymer is removed inside a column packed with benzyl chloride initiator particles. For both 100 and 150 μL/min IC AAM columns did not bleed acrylamide. This allows for ICAAM columns to have higher resolution.

Compared to a FP column. ICAAM columns gave higher resolution initially and over time for intact Ribonuclease B and its glycoforms. Since the polymer layers were grown on particles that are already packed into the column, the ICAAM column proved to be more stable than the conventionally packed column.

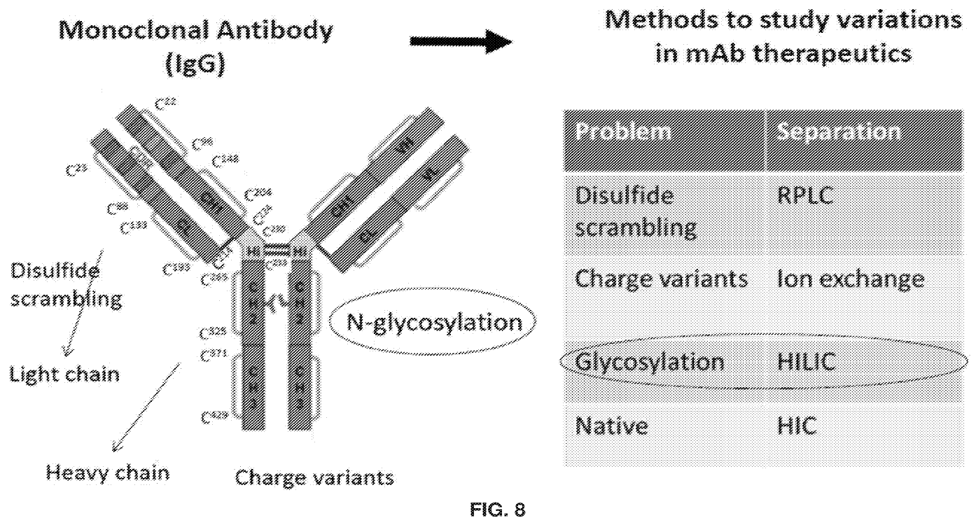

ICAAM columns will also be evaluated to separate monoclonal antibodies (mAbs). See FIG. 8.

### Example 2

Chromatographic resolution and colunm-to-column reproducibility were further evaluated for in situ polymer growth by hydrophilic interaction liquid chromatography for the model glycoprotein ribonuclease B.

Materials. Nonporous silica particles (750 nm) were purchased from Superior Silica (Tempe, Ariz.), Empty stainless steel columns (2.1 mm I.D., 30 mm length), reservoirs (4.6 mm I.D., 150 mm), and frits (0.5 μm pore diameter) were purchased from Isolation Technologies (Middleboro, Mass.). Stainless steel tubing, ferrules, and internal nuts were all purchased from Valco Instruments Co. Inc. (Houston. Tex.). Methyltrichlorosilane and ((ehloromethyl)phenylehyl)trichlorosilane ((Iciest, inc,, Morrisville, Pa.), acrylamide, sodium ascorbate. Tris[2-(dimethylamino)ethyl]ainine (Me6TREN), acetonitrile, trifluoroacetic acid (TFA), and Ribonticlease B (Sigma-Aldrich. St. Louis, Mo.). and copper (II) chloride (Ac.ros Organics, Morris Plains, N.J.) were used. All protein samples were prepared in ultrapure water at a concentration of 1.0 mg/mL.

Saytuition of particles. The silica particles were calcined at 600° C. for twelve hours, then annealed at 1050° for three hours, and rehydroxylated overnight in 0.1 M HNO3. Particles were then rinsed in ultrapure water and dried in a 60° C. vacuum oven. SEM showed that the particles decreased in diameter to 0.62 μm from the heating steps. The particles were suspended in dry toluene by sonication and modified with a 2% (v/v) ((chloromethy)phenylethyptrichlorosilane solution. The particles were allowed to react overnight and stirred with a stir bar. After reaction, the particles were rinsed three times with dry toluene, and then dried for two hours in a 120° C. oven to condense the siloxane bonds.

Ex situ AGET ATRP. In a 25 mL round bottom flask, 500 mg of silylated particles and 4.4 g acrylamide were suspended together by sonication in 20 mL of 75:25 MO:IPA (V:\/), Two other solutions were made: a copper solution containing, 40 mg copper (II) chloride and 80 μL Me6TREN, and a solution containing 20 mg sodium ascorbate. These were also prepared in 2.5 mL of 75:25 H2O:IPA. Afterwards, the copper/Me6TREN solution was added to the suspension, followed by the sodium ascorbate solution; this vessel was left to react for 55 min under sonication. The particles were then rinsed three times with water and dried in a vacuum desiccator at room temperature to allow weighing. Finally, 154 mg of particles were suspended in 75:25 water:IPA and packed into 2.1 mm×30 mm. stainless steel columns under sonication using a high pressure pump (Laboratory Alliance of Central New York, LLC. Syracuse, N.Y.).

In situ AGET ATRr .A solution containing the same reaction solution as for ex situ polymerization was prepared, but without the particles. The solution was poured into a plugged, 2.1 mm×150 mm reservoir column. A 2.1 mm×30 mm column was packed with silylated particles suspended in acetonitrile. The reservoir and column were connected in series. The reaction solution from the reservoir was pumped into the column starting at a high flow rate (200 μL/min) until the reaction mixture dripped from the end of the column. The flow rate was then lowered to 100 and the polymerization reaction was allowed to proceed for the desired time period, After reaction, the column was rinsed with water for 10 min at 100 μL/min.

Chromatography, HILIC separation of ribonuclease B was performed using a Waters Acquity UPLC 1-Class system (Milford, Mass.) with UV absorbance detection. Solvent A was water with 0.1% TFA and solvent B was acetonitrile with 0.1% TFA. The gradient was 75-60% B over 20 minutes. Absorbance wavelength was set to 215 nm. The flow rates were 100 UL/min and 150 utimin. The column temperature was 30° C. and the injection volume was 2 μL.

### Results

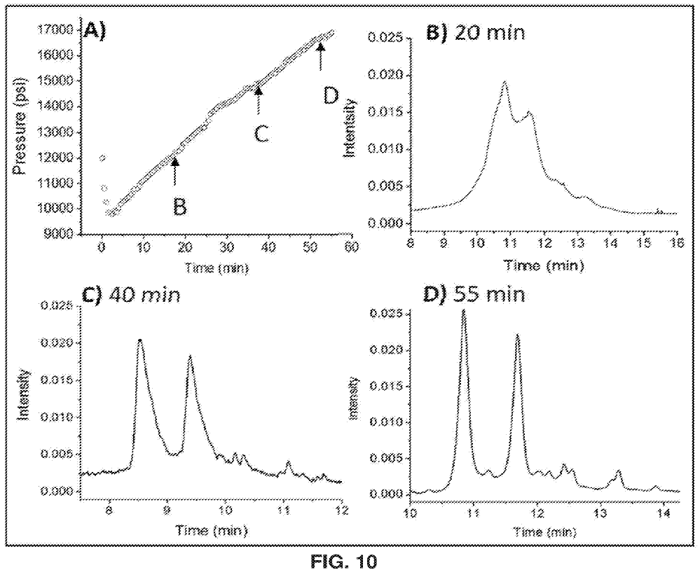

To monitor in situ polymer growth, the column back-pressure was recorded as a function of time while the reagent solution of acrylamide monomer and catalyst were continuously flowed through the column. A plot of column back-pressure vs. time during polymer growth is provided in FIG. 10A. There is an initial dip because the initial flow rate was set to 200 μL/min to fill the entire length of the column quickly, and after I min, the flow rate was switched to 100 μL/min in anticipation of the increase in back-pressure. Since the column dead volume is 50 μL, the reagent fills the column in only 15 s to give uniform reaction conditions along the length of the column during the 55 min growth time. The increase in back-pressure over the course of the 55 min reaction time was shown to be considerable, changing from 10,000 to 17,000 psi. The 55 min reaction time was the same as that used for the particles coated ex situ. Columns were made for varying reaction time, and the HILIC separation of the ribonuclease B glycoforms is shown for the cases of 20, 40, and 55 min reaction times in Figure OB, C and D., respectively. These establish that significantly shorter reaction times are not feasible. Consistent with previous results, a sufficiently thick polymer is needed [14]

The back-pressure increase in FIG. 2A is a consequence of the decrease in porosity caused by the growth of the polymer. One can calculate this decrease in porosity over time using the Kozeny-Carman equation.

$$\frac{P}{L} = \frac{180 \cdot η}{{d}_{p }^{2}} \cdot \frac{{( 1 - ɛ )}^{2}}{{ɛ}^{3}} \cdot \frac{Q}{π {r}^{2}} \qquad ( 1 )$$

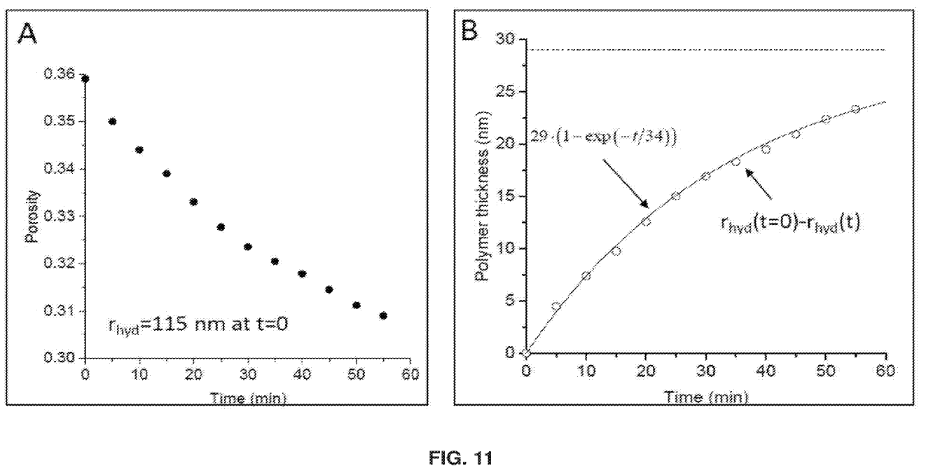

The porosity is ε, the volume flow rate is Q, the column radius is r, and all other variable have their usual meanings. The viscosity of the 75:25 water:IPA (V:V), which converts to a mole fraction of 0,925 water, is 1.1 niPas [23]. Equation 1 is strictly true if the particles are spheres of diameter, dp, which is not exactly the same as spheres of dp with a thin coating, so it is assumed that the polymer is thin compared to the particle diameter. FIG. 11A gives a plot of the calculated porosity as a function of time, showing that it decreases from an initial value of 0.36 to 0.31 at the end of the reaction,

The decrease in porosity for the growing polymer can be used to estimate the polymer thickness through the relation between the hydrodynamic radius of the fluid channel and the porosity.

$${r}_{hyd} = \frac{{d}_{p}}{3} \cdot \frac{ɛ}{( 1 - ɛ )} \qquad ( 2 )$$

The initial hydrodynamic radius, i.e., before polymer growth, is 115 nm. After the polymer has grown fhr 55 min, the final hydrodynamic radius was calculated to be 92 nm. The difference between the two numbers is the polymer thickness. FIG. 11B shows the increase in calculated polymer thickness with reaction time, reaching a thickness of 25 urn after 55 min, This is less than 10% of the particle radius, so the application of the model is reasonable. It is noted that the polymer thickness would change with solvent. Since the AGET A.TRP reaction is conducted in more aqueous conditions, the polymer is expected to be more swollen, giving a higher back-pressure compared to the less aqueous conditions of HILIC.

Microanalysis of the packing media showed that the carbon loading by mass is 2.0% for both ex situ and in situ polymerization. This means that materials with the same surface coverage are being compared, One can estimate the density of silica on the surface for the in-situ polymer growth. SEM showed the silica particles to have a final diameter of 0.62 μm after processing, and the coverage of nitrogen, which neglects the initiator layer, is 0.53±0.01%, then the molar coverage of acrylamide monomer is 86 μmol/m2, based on a density of 2.2 g/cm3 for silica. This is 23% of the density of liquid acrylamide. Since non-cross-linked polyacrylamide can swell in water to as much as 10 times its volume in methanol [24], one can presume that water accounts for the large hydrated volume of the polymer layer. The nonlinearity of the polymer growth in FIG. 11B is thus not attributed to steric hindrance; instead, it is owed to radical termination, which is likely from the high catalyst concentration. Whether a more linear polymer growth, or a longer growth time, improves HILIC will he investigated in subsequent work, but the quality of the separation in Figure IOD is comparable to previous results.

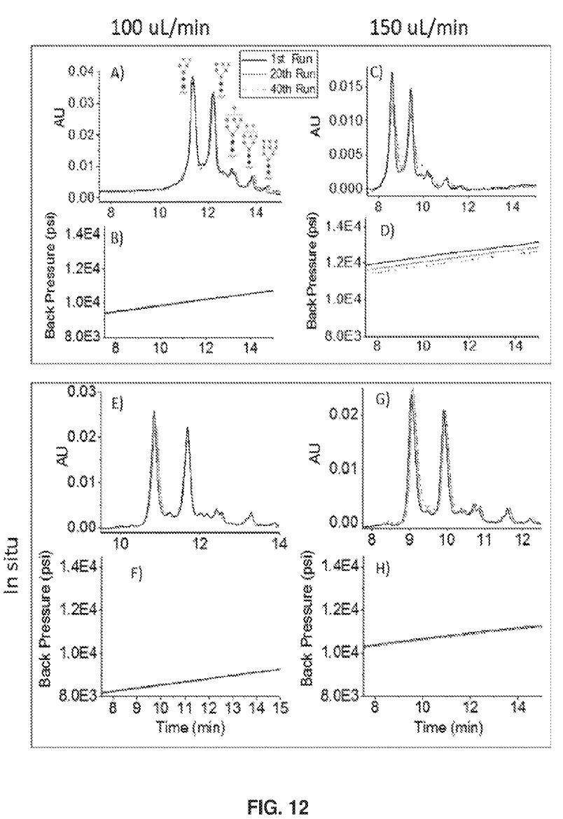

Among the multiple columns produced via ex situ growth conditions, more variability in resistance to flow was exhibited compared to in situ grown columns. Colunms with lower resistance exhibited less long-term stability for the ex situ case, but not for the in situ case. This is illustrated in FIG. 12. This figure has a high information content, and the first feature to be considered is that most columns were tightly packed, limiting the flow rate to 100 μL/min. More tightly packed columns could not reach as high of a flow rate and had a shorter to. Tight vs. loose packing seems to be happenstance. For one such column, the HILIC chromatogram for ribonuclease B is shown in panel A for ex situ polymerization, showing a good quality separation. The five glycoforms are clearly visible, and the resolution is competitive or better than the commercial columns studied previously [14]. This same panel shows a sampling of replicates: the first, twentieth, and fbrtie.th runs, and. these line up well, revealing that the stability exceeds 40 runs. A graph of the column back-pressure during the gradient is provided below in panel B, establishing that column resistance is constant from run to run, Back-pressure rises during the HILI. separation as the increasing proportion of water increases the viscosity of the mobile phase. The chromatogram for a more loosely packed column made by ex situ polymerization is shown in panel C, where the flow rate was 150 μL/min. The data show that the quality of the separation was initially high, but the quality degraded significantly over the course of 40 runs. Panel D shows the back pressure during the gradient elution. The entire curve also dropped over the course of the 40 runs. The column failure is thus associated with decreasing resistance to flow. This indicates bed collapse, i.e., the particles moved to open lower resistance channels or some polymer was lost to increase porosity. The two columns initially gave similar resolution, they differed only in how tightly the particles were packed. It is noted that the more loosely packed columns did not fail over these time frames at the lower flow rate and pressure, hence it is a combination of looser packing and high compression that causes column failure, Tighter packing helps stability, presumably by locking the particles in place.

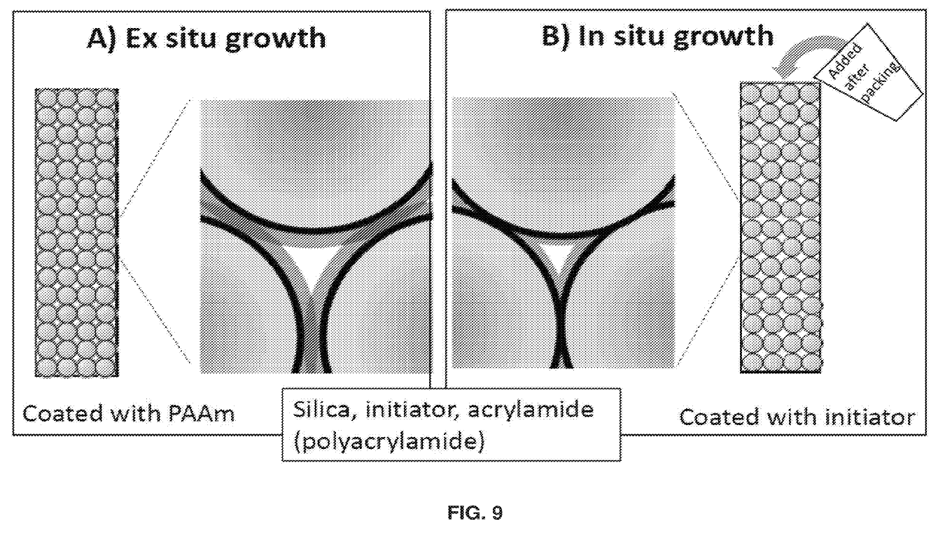

FIG. 12 also presents data for in situ polymer growth. Panels F and F show, respectively, the chromatograms for the more tightly packed column and the back-pressure vs. time during the gradient separation. The chromatograms and back-pressure curves again line up for the 40 runs. For the more loosely packed column made by in situ polymerization, the stability is now shown to be higher. Panels G and H show that there is minimal degradation of the quality of the separation after 40 runs, and the back-pressure did not change over 40 runs. This indicates that the bed and the polymer remain intact despite the looser packing for the case of in situ polymerization. This supports the notion that solid contacts between particles, depicted in FIG. 9, enhance column stability.

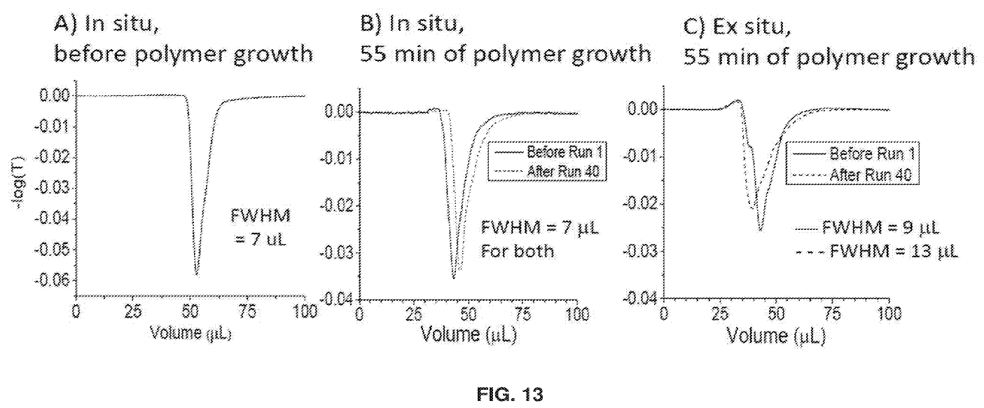

One way of interrogating bed collapse for loosely packed columns is to measure the profile of an unretained peak. This was done by injecting acetonitrile into 50:50 water:aeetonitrile and eluting isocratically. The refractive index change gives a negative going peak. FIG. 13 provides the results. In FIG. 13A, the unretained peak profile is shown for the in situ polymerization, but before the polymer is grown. This allows a subsequent determination of how much the polymer affects uniformity of the flow paths through the column. FIG. 13B shows that the peak width, measured by the full-width at half-maximum (FWHM) is the same before and after in situ polymerization, indicating that the polymer growth does not significantly affect uniformity of flow through the column. Comparing panels 13A and 13B also shows that the mobile phase volume decreased with polymerization, as expected. Panel B shows that the mobile phase volume increased slightly, by 3 after 40 runs, perhaps due to loss of polymer, but the peak width remained the same, indicating that the flow paths remained homogeneous. For the case of ex situ polymerization, panel C shows, for the first run, the mobile phase volume was virtually identical to that for in situ polymerization, but the peak width was somewhat wider, 9 μL. This is a manifestation of the difficulty in packing particles after they have been polymerized, Panel C also shows that after the 40 runs, the peak width became significantly wider, 13 μL, indicating that the flow paths became more heterogeneous. The mobile phase volume becomes smaller, indicating that wider channels were opened. This interpretation is supported by the column back-pressure dropping, as was shown in FIG. 12D. The smaller mobile phase volume and greater heterogeneity of flow paths signal the onset of bed collapse, consistent with the degradation of the chromatographic behavior for this column. Minimizing bed collapse may be achieved by lowering the flow rate for loosely packed ex situ columns.

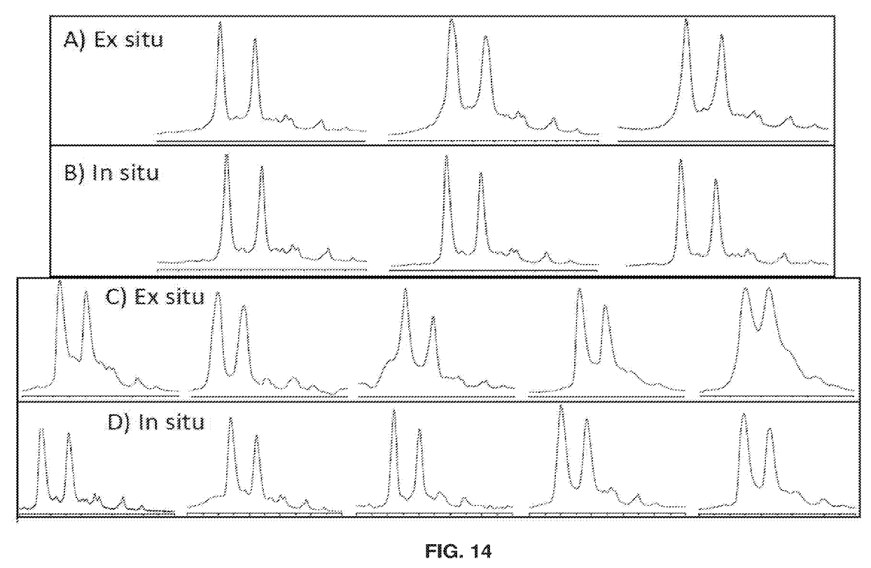

To assess column-to-column reproducibility of the in situ vs, ex situ polymerization, eight columns were made by each method. A different batch of particles was used for each ex situ column presented here. Studies (not shown) of columns made with the same batch of particles showed as much variability. The chromatographic behavior of the 16 columns is shown in FIG. 14. In FIGS. 14A and 14B, the best three columns are compared for ex situ and in situ polymer growth. This shows that the in situ growth results in better resolution. The widths of the unretained peaks, discussed earlier, are much narrower than the protein peaks, hence the packing homogeneity is not responsible for the improved resolution. It is possibly due to the polymer density being uniform for in situ growth, as opposed to the compressed polymer layer near particle contacts for ex situ growth. FIG. 14C and 14D compare the other five columns. For ex situ growth, three of the five columns in FIG. 14C have unacceptably low resolution. These show that the quality is more variable for the ex situ growth. For the in situ growth, the worst column is comparable to the commercial columns previously studied [14]. Improvements can be made for the in situ growth, which gives a 50% yield, with four of the eight columns giving high resolution. Most notably, optimization of the packing process, as well as the ,.GET ATRP conditions, might improve resolution.

The problem of preparing stable, reproducible columns with a polyacrylamide bonded phase for HILIC of intact proteins is addressed by growing the polymer bonded phase in the column after the solid particles are packed. This in situ growth is shown to give a better HILIC stationary phase, in addition to improvements in stability and reproducibility. The use of the AGET ATRP reaction scheme facilitates in situ growth by removing the necessity of maintaining an oxygen-free environment for the Cu(i) catalyst. The inherent slowness of the reaction is overcome by use of a higher Cu(I) concentration. This gives some radical termination, but is able to generate a polymer thickness estimated to be 23 nm in 75:25 water:IPA (V:V) after a 55 minute reaction time. The methodology can presumably be adapted to other types of polymeric bonded phases made by radical polymerization.

### Example 3

Columns were also prepared with polymethyimethacrylate using the methods describes above in Example 2, but with one difference: the flow was stopped after 5 min, and the reaction was allowed to proceed for 55 min, then the reagents were flushed out. Nonporous silica particles of 1.2 .1111 in diameter were chemically modified with (chloromethyl)phenylethyldimethylchlorosilane by refluxing in toluene with a butylamine catalyst, and then endcapped. 0.26g of these particles were added to 2 ml acetonitrile (ACN). The particles were sonicated until they were fully suspended in the ACN. The solution was then, which served as a reservoir, A 5-cm long, 2.1-nim internal diameter stainless steel column was connected to the 10-cm column. This apparatus was attached to a dual piston packing pump ChromTech Model CP Apple Valley, Minn.; USA). The apparatus was immersed into a sonicator. The sonicator was turned on and the packing pump was set to a flow rate of 0.2mUmin pumping ACN. Once the pressure stabilized, the flow rate of the pump was slowly increased until the pump reached its maximum pressure. The flow rate achieving max pump pressure was maintained for 20 minutes. The sonicator was then turned off and the pump was allowed to depressurize. This process was repeated an additional two times.

The packed column was flushed with a solution of 45% water 55% IPA. The 5.-cm long column of packed particles was connected to a 10cm long, 4.6-mm internal diameter column, 6m1 of methyl methacrylate (MMA) was added to a solution of 20 mL of 45% water 55% IPA. 0.020 g of sodium ascorbate was weighed out and added to a 2.5 mL solution of 45% water 55% IPA. 0.040 g of copper (II) chloride was weighed out and added to a 2.5 ml solution of 45% water 55% IPA. 80 μL of Tris(2-dimethylaminoethyl)amine (Me6TREN) was added to the copper (II) chloride solution. First, the copper (II) chloride solution was added to the methyl methacrylate solution, followed by the sodium ascorbate solution. The solution was then added to the 10-cm long column and attached to the dual piston packing pump. A 45% water 55% IPA solution was pumped through the apparatus at a flow rate of 0.2 mL/min. After blue solution was observed exiting the column, the flow rate was decreased to 0.1 ml/rain for five minutes. Following the 5 minutes, the flow was stopped and the column was removed from the pump. After 55 minutes, the column was attached directly to the packing pump and flushed with the water/IPA solution for 10 minutes to remove any unreacted chemicals.

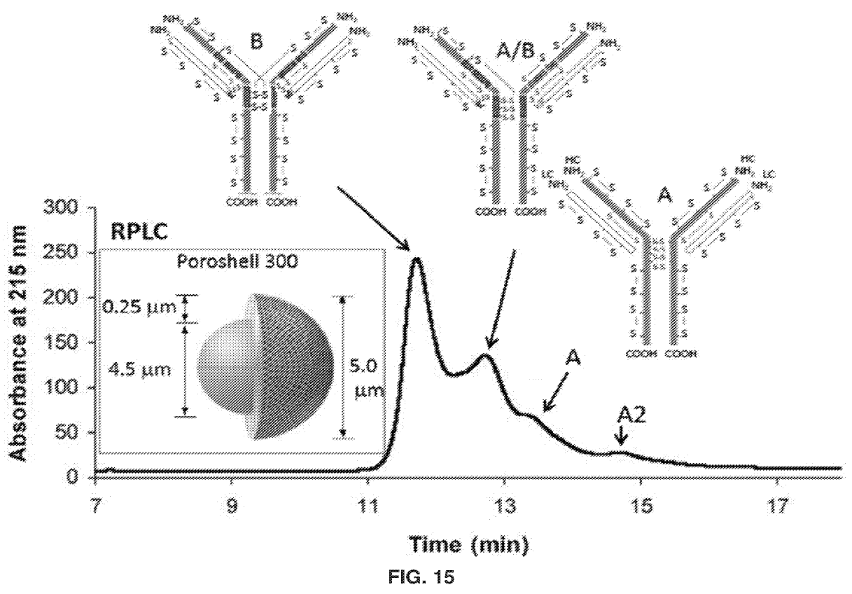

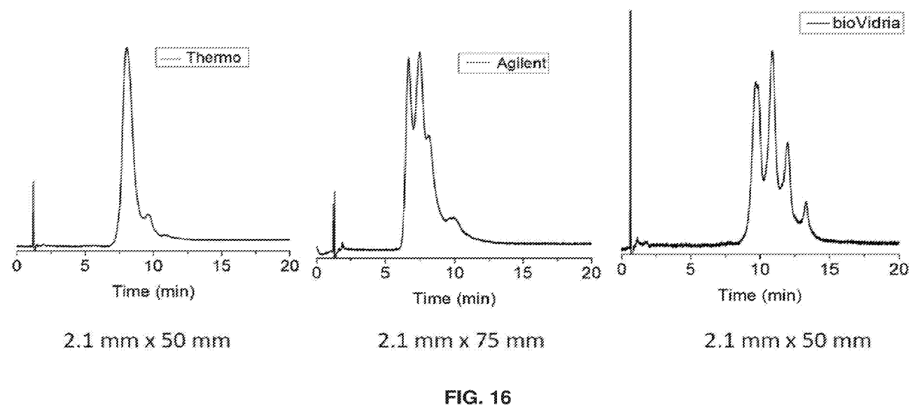

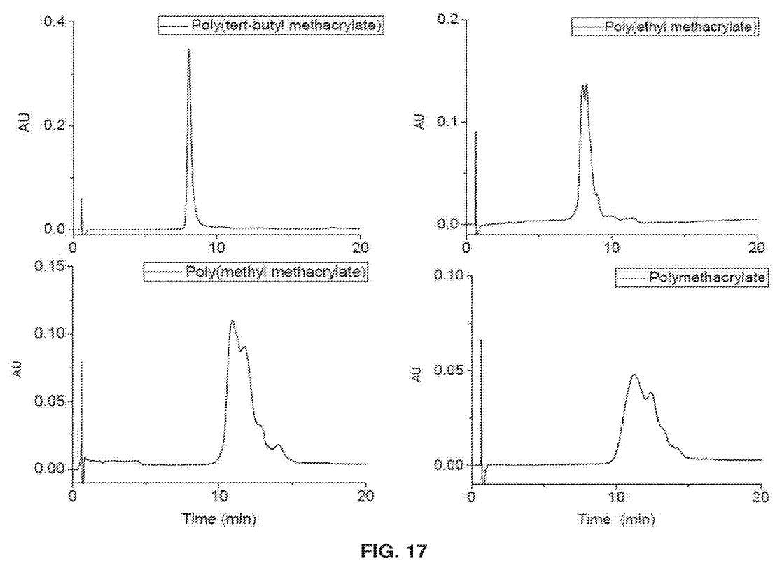

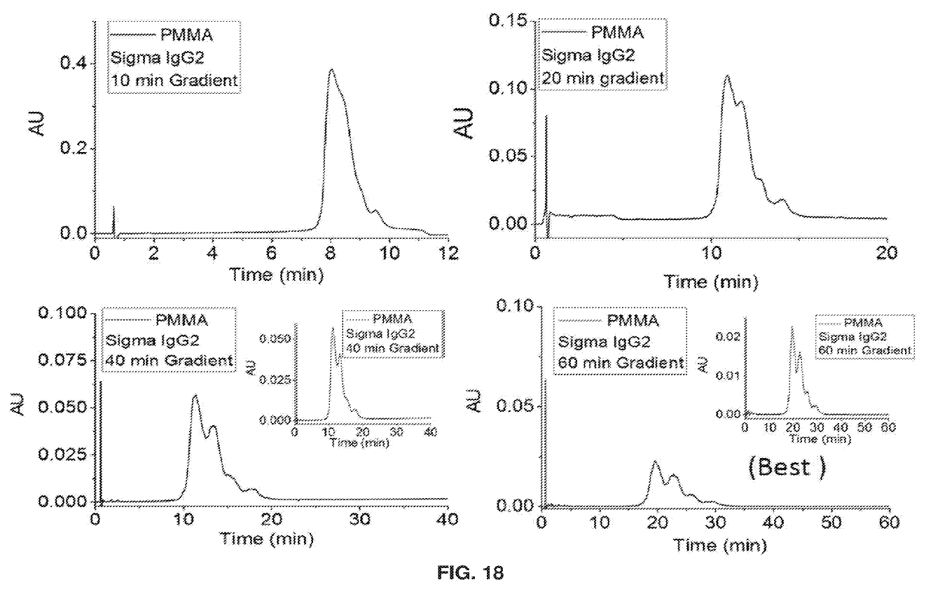

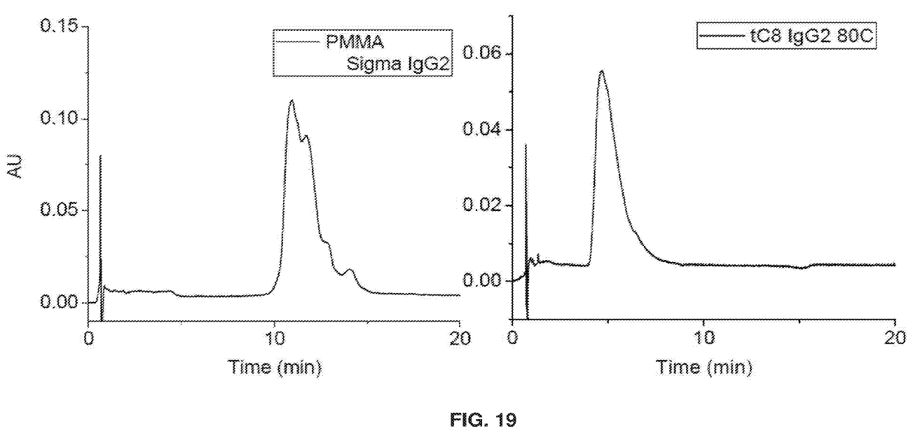

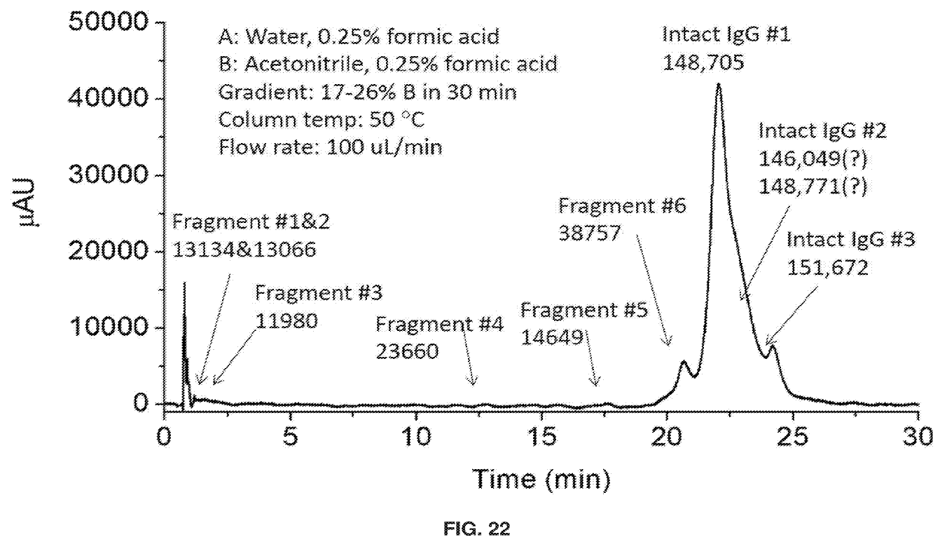

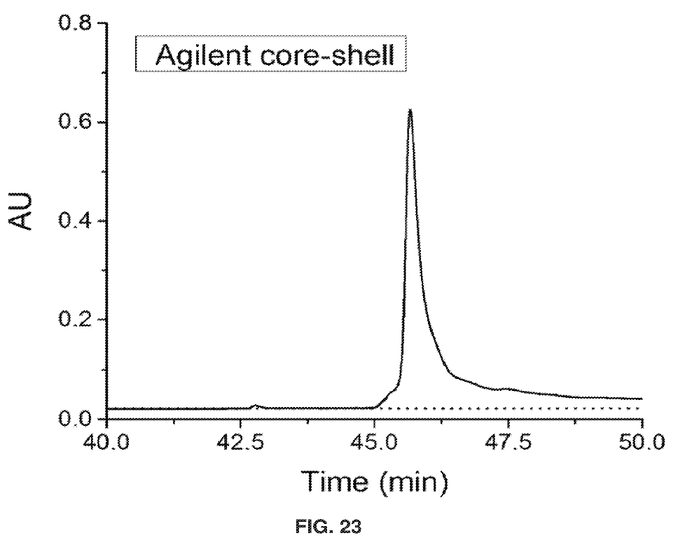

Testing method: All chromatography experiments were performed on a Waters Acquity UPLC I-Class binary pump system (Milford, Mass.; USA). The IgG2 sample was prepared in a 1M phosphate buffer solution (pH 7.2), Mobile phase A was 1120 with 3% butanol and 0.1% trifluoroacetie acid (TFA). Mobile phase B was ACN with 3% butanol and 0.1% TFA, Gradient of 4% B over 20 minutes were used at 0,1 mL min, 80° C. The results for IgG2 proteins are shown in FIGS. 15-21. Results for an IgG4 protein are shown in FIGS. 22-23.

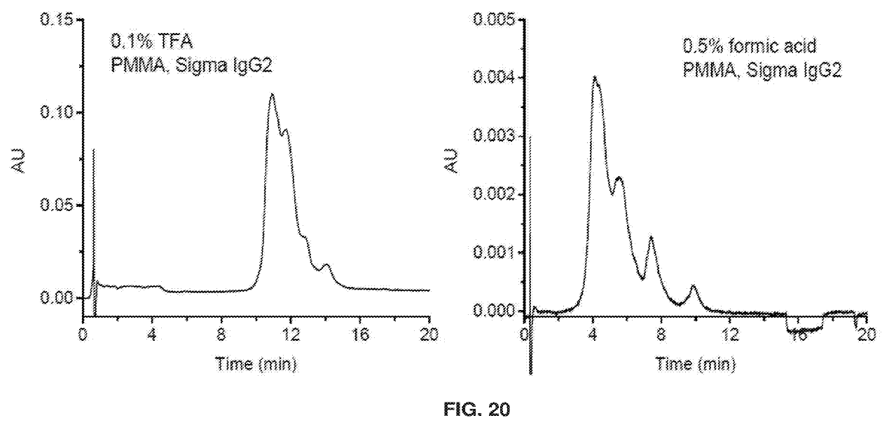

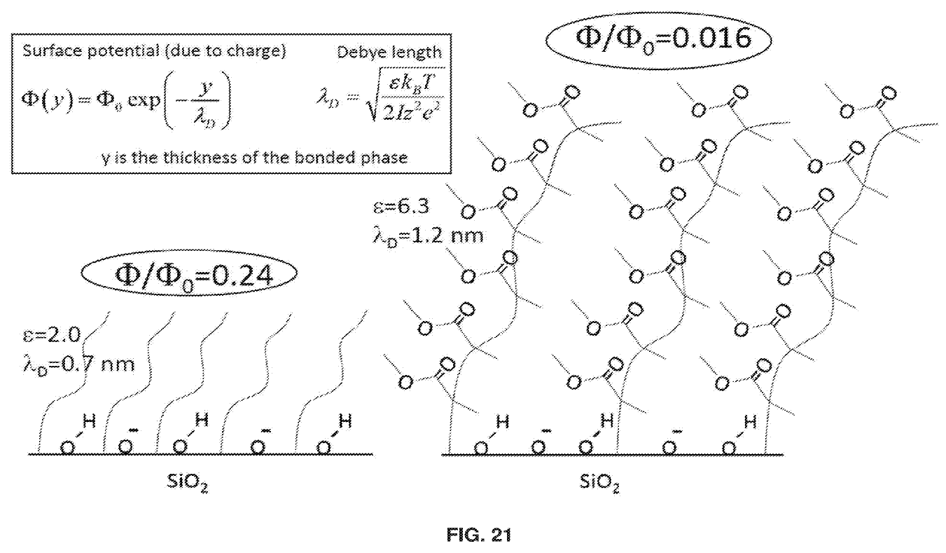

It would be desirable to use formic acid as a modifier because it slows for mass spectrometry, but the chromatography does not work well for IgG proteins. Trifluoroacetic acid CITA) is used, which helps the chromatography but ruins the mass spectrometry. Surprisingly, for polymethylmethaerylate (PMMA), selectivity is better with formic acid, not worse. See FIG. 20. Formic acid is a weaker acid, so it makes the surface more charged, therefore, the separation deteriorates due to unwanted charge interactions, While not wishing to be bound by theory, it is thought that the polymethylmethacrylate (PMMA) shields this charge by being thicker. The PMMA layer has about 15X lower interfacial potential due to its 5 nm thickness, compared with 1 nm for conventional hydrocarbon bonded phase. See FIG. 21, Comparison of a polymethylmethacrylate column and an Agilent core-shell side wide-pore column for an IgG4 protein is shown in FIGS. 22 and 23. The polymethyltriethaerylate column shows separation of fragments, while the Agilent column is not usable for this application.

[1] Williams. T,, Gel Permeation Chromatography - A Review, J. Mater. Sci. 1970, 5 811-820.

[2] Stein, A., Kiesewetter, A., Cation exchange chromatography in antibody purification: pH screening for optimised binding and HCP removal, J. Chromatogr. B 2007, 848, 151-158.

[3] Fahrner, R. Blank, G. S,, Zapata, G. A., Expanded bed protein A affinity chromatography of a recombinant humanized monoclonal antibody: process development, operation, and comparison with a packed bed method, J. Biotechnology 1999, 75, 273-280.

[4] Mata-Gomez, M. A., Yaman. S., Valencia-Gallegos, J. A.. Tani, C., Rito-Palomares, M., Gonzalez-Valdez, J.. Synthesis of adsorbents with dendronic structures for protein hydrophobic interaction chromatography, J. Chromatogr, A 2016, 1443, 191-200.

[5] Svec. F., Quest for organic polymer-based monolithic columns affording enhanced efficiency in high performance liquid chromatography separations of small molecules in isocratic mode, J. Chroinatogr. A 2012, 1228, 250-262,

[6] Sarafraz-Yazdi, A,, Razavi, N,, Application of molecularly-imprinted polymers in solid-phase microextraction techniques. TrAC 2015, 73, 81-90.

[7] Patten. T. E., Xia, J. H., Abernathy. T., Matyjaszewski, K., Polymers with very low polydispersities from atom transfer radical polymerization. Science 1996, 272, 866-868.

[8] Huang, X. V., Wirth, M. J.. Surface-initiated radical polymerization on porous silica, Anal. Chem. 1997, 69, 4577-4580.

[9] McCarthy, P., Chattopadhyay, M., Millhauser, G. L.. Tsarevsky, N. V., Bombalski, L., Matyjaszewski, K.. Shiintnin, D.kvdalovic, N., Pohl, C., Nanoengineered analytical immobilized metal affinity chromatography stationary phase by atom transfer radical polymerization: Separation of synthetic prion peptides, Anal. Biochem. 2007, 366, 1-8,

[10] Schwellenbach, J., Kosiol, P.. Softer, B,. Taft. F., Villain, L.. Strube, J,, Controlling the polymer-nanolayer architecture on anion-exchange membrane adsorbers via surface-initiated atom transfer radical polymerization, React. Funct. Polym. 2016, 106, 32-42.

[11] Shen, Y., Qi, L., Wei, X. Y., Zhang, R. Y., Mao, L. Q,, Preparation of well-defined environmentally responsive polymer brushes on monolithic surface by two-step atom transfer radical polymerization method for HPLC, Polymer 2011, 52, 3725-3731.

[12] Liu. I., Lin, D. Q., Wu, Q. Zhang, Q. L., Wang, C. X., Yao. S. J., A novel polymer-grafted hydrophobic charge-induction chromatographic resin for enhancing protein adsorption capacity, Chem, Eng. J. 2016, 304, 251-258,

[13] Kanazawa, H., Okano, ‘I’.. Temperature-responsive chromatography for the separation of biomolecules, J. Chromatogr. A 2011, 12.18, 8738-8747.

[14] Zhang, Z.., Wu, Z., Wirth, M. J., Polyacrylamide brush layer for Hydrophilic Interaction Liquid Chromatography of intact glycoproteins, Journal of chromatography. A 2013, 1301, 156-161,

[15] Lazar, .1., Park, H., Rosencrantz, R. R.., Baker, A.. Foiling. Schnak.enherg, U., Evaluating the Thickness of Multivalent Glycopolymer Brushes for Lectin Binding, Macromolₒ Rapid Comm. 2015, 36, 1472-1478.

[16] Jain, P., Baker, a L., Bruening, M. L., Applications of Polymer Brushes in Protein Analysis and Purification, .A inu Rev, Anal. Chem. 2009, 2, 387-408.

[17] Guiochon, C F.. Farkas. T., Chian S aj onz, H., Koh, 3. H.. Sarker, M.. Stanley, B. 3., Yun. I., Consolidation of particle beds and packing of chromatographic columns, J, Chromatogr, A 1997, 762, 83-88.

[18] Wei B. Co, Rogers, B. J., Wirth, M. J.. Slip Flow in Colloidal Crystals for Ultraefficient Chromatography, J. Am. Chem. Soc. 2012, 134, 10780-10782.

[19] Godinho, J. M., ReisingAL E.. Tallarek, U., Jorgenson, J. W.. Implementation of high slurry concentration and sonication to pack high-efficiency, meter-long capillary ultrahigh pressure liquid chromatography columns, J. Chromatogr. A 2016, 1462, 165-169.

[20] Zaman, A. A., Bjelopavlic, Mo, Moudgil, B. M., Effect of adsorbed polyethylene oxide on the rheology of colloidal silica suspensions, J. Colloid Interf. Sci. 2000, 226, 290-298.

[21] Ren, H., Zhang, X., Li, Z., Liu, Z., Li, J.. Silica-supported polymeric monolithic column with a mixed mode of hydrophilic and strong cation-exchange interactions for microcolumn liquid chromatography, J Sep Sci 2016, 1-8.

[22] Jakubowski, W., Matyjaszewski, K.A.ctivator Generated by Electron Transfer for Atom Transfer Radical Polymerization, Macromolecules 2005, 38, 4139-4146.

[23] Pang. F. M,. Seng, C. E. Teng. T.17,, Ibrahim, M, R, Densities and viscosities of aqueous solutions of 1-propanol and 2-propanol at temperatures from 293.5 K to 333,15 K, J. Mol. Lig. 2007, 136, 71-78.

[24] Li, A.,, R.arnakristma. S, N., Kooij, E S., Espinosa-Marzal, R. M.. Spencer, N. D., Polytacrytamide) films at the solvent-induced glass transition: adhesion, tribology, and the influence of crosslinking. Soft Matter 2012, 8, 9092-9100.

We claim:

1. A method of preparing a chromatography column, comprising
(i) packing the chromatography column with support particles to form packed support particles within said column; and
(ii) forming a polymer coating on the packed support particles.

2. The method of claim 1, wherein the support particles comprise silica, alumina, titania, zirconia, magnetite, or combinations thereof.

3. The method of claim 1, wherein the support particles comprise an initiator for polymerization.

4. The method of claim 1, further comprising introducing a pre-polymer solution to the packed support particles.

5. The method of claim 1, wherein the step of forming a polymer coating comprises growing the polymer coating on the packed support particles.

6. The method of claim 1, wherein the step of farming a polymer comprises activators generated by electron transfer and atom-transfer radical polymerization.

7. The method of claim 3, wherein the step of forming a polymer comprises reversible addition fragmentation chain transfer, and wherein the initiator is cyanomethyl [3-(trimethoxysilyl)propyl]trithiocarbonate.

8. The method of claim 3, wherein the step of forming a polymer atom-transfer radical polymerization, and wherein the initiator is ((chloromethypphenylethyl)trimethoxysilane, 3-trimethoxysilyl) propyl 2-bromo 2-methylpropionate, [11-(2-bromo-2-methyl)propionyloxy]undecyltrichlorosilane or combinations thereof.

9. The method of claim 1, wherein the support particles comprise an initiator on a surface of the support, and wherein the step of forming a polymer coating comprises growing the polymer coating on the surface of the packed support particles.

10. The method of claim 1, wherein the packed support particles comprise hard contacts between support particles.

11. The method of claim 1, wherein the polymer coating has a substantially uniform density throughout the packed support particles.

12. The method of claim 1, wherein the polymer comprises styrenes, acrylates, acrylamides, methacrylates, methacrylamides, vinyl esters, vinyl amides or combinations thereof.

13. The method of claim 1, wherein the thickness of the polymer coating is about 1 to about 100 nm.

14. The method of claim 1, further comprising measuring the back-pressure over time during the step of forming a polymer coating.

15. The method of claim 3, wherein the polymer is a peptide or oligonucleotide, and the initiator is triethoxyaminopropyisilane, glycidoxypropyltrimethoxysilane or combinations thereof.

16. A chromatography column prepared by the method of claim 1,

17. A chromatography material comprising
(i) support particles, and
(ii) an initiator on a surface of the support particles.

18. A chromatography column comprising
(i) support particles, wherein the support particles comprise hard contacts between support particles;
(ii) an initiator on the surface of the support particles; and
(iii) a polymer coating on the surface of the support particles.

19. The chromatography column of claim 13, wherein the polymer coating has a substantially uniform density throughout the packed support particles.

20. The chromatography column of claim 13, wherein the support particles comprise silica or polymer.
